(19) United States
(12) Patent Application Publication
(10) Pub. No.: US 2011/0069820 A1
(43) Pub. Date: Mar. 24, 2011

(54) MOBILE MEDICAL DIAGNOSTIC OR THERAPY APPARATUS

(76) Inventors: Reinhold Hartwich, Pleystein (DE); Norbert Herrman, Ebnath (DE); Andreas Limmer, Seybothenreuth (DE); Manfred Sechser, Neusorg (DE)

(21) Appl. No.: 12/884,416

(22) Filed: Sep. 17, 2010

(30) Foreign Application Priority Data
Sep. 24, 2009 (DE) 10 2009 042 924.7

(51) Int. Cl. H05G 1/02; B62B 5/00; B62B 5/04; B62B 3/00

(52) U.S. Cl. 378/198; 280/80.1

(57) ABSTRACT

A mobile medical diagnostic or therapy apparatus has at least one Bowden cable element via which the travel movement of the diagnostic or therapy apparatus is controlled. The use of one or more Bowden cable elements allows them to be placed relatively freely in the mobile diagnostic or therapy apparatuses and they require very little space.

### BACKGROUND OF THE INVENTION

1. Field of the Invention

The invention concerns a mobile medical diagnostic or therapy apparatus.

2. Description of the Prior Art

Mobile medical diagnostic or therapy apparatuses, in particular x-ray diagnostic apparatuses in the embodiment as a mobile C-arm x-ray imaging device, are in widespread use in the field of medicine. The term “C-arm” generally designates a C-shaped element that has an x-ray source and an image receiver or detector that are arranged at opposite ends of the C-arm. In this way x-rays emitted from the source strike the image receiver and are detected. In a medical application case, the C-arm is positioned around the body part to be irradiated such that this is arranged between x-ray source and image receiver and can be exposed to the x-ray radiation. The data generated by the detector are shown on a monitor and used for the diagnosis.

Known medical diagnostic or therapy apparatuses have steering and braking devices that enable a controlled mobility of the apparatuses by the physician or the operator.

In a known embodiment of a braking device in mobile medical diagnostic or therapy apparatuses, the movements of individual rollers or all rollers arranged on the underside of the apparatus can be blocked by mechanical brakes or electromechanically activated brakes. This requires a complicated force transfer if the force must be transferred from a braking activation element arranged at operating height with respect to the wheels on the apparatus underside. A shaft and a complex rod structure are typically used, which occupy space and lead to difficulties in the arrangement of a mobile diagnostic or therapy apparatus, and are associated with high costs. Even a braking system of a mobile medical apparatus that is based on hydraulic components, as described in Utility Patent DE 29809 676 U1, has the disadvantages of a relatively large space requirements and the high costs.

Known embodiments of steering devices of mobile diagnostic or therapy apparatuses are characterized by the transfer of the steering movement from the steering arm to the wheels to be steered requiring a complex and space-intensive connection. The steering handle arranged at the operating level is horizontally obstructed in the apparatus and connected directly with a steering shaft via which the steering movement is relayed vertically downward. At the bottom end of the shaft a gearwheel is arranged that transfers the steering movement via a horizontally running chain and via various deflections from the rear part of the mobile apparatus forward to the steering wheels. Also disadvantageous in such solutions are the large space requirement in the limited space of a mobile diagnostic or therapy apparatus and the high costs associated with this solution.

### SUMMARY OF THE INVENTION

An object of the present invention is to overcome these disadvantages and to provide an improved device for controlled movement of a mobile diagnostic or therapy apparatus.

The invention concerns a mobile medical diagnostic or therapy apparatus with a travel movement controlled by at least Bowden cable element. The advantage of the use of one or more Bowden cable elements is that these can be placed relatively freely in the mobile diagnostic or therapy apparatus and require only very little space. The manufacturing costs of the apparatus also can be reduced since Bowden cable elements are cost-effective components.

In a further embodiment, the travel movement can be controlled either by only a braking device, by only a steering device, or by a braking and steering device. Individual requirements for the control capability of the apparatus thus can be satisfied depending on the respective application case.

In a further embodiment, the braking device can embody the at least one Bowden cable element. One or more wheels can therefore advantageously be selectively braked.

Furthermore, the at least one Bowden cable element can be arrested. It is thereby possible to maintain the position of the apparatus and protect against an unwanted movement.

In a further embodiment, the steering device can have the at least one Bowden cable element. The requirement for an individual steering capability of the apparatus is advantageously achieved with this arrangement.

Furthermore, the steering device can include at least one gearwheel. By using gearwheels, steering movements can advantageously be transferred to the wheels of the apparatus without the assistance of space-intensive rod structures.

In a further embodiment of the invention, at least one front wheel and/or at least one rear wheel can be steered via the braking device. Steering of the apparatus is therefore enabled without a turning of the apparatus by 180° being required in a repositioning of the apparatus.

Furthermore, the apparatus can have a braking-steering handle element with which the braking device and the steering device can be operated together. Separate handles for steering and braking are thereby omitted, and the movement is enabled via only one handle.

In a further embodiment, the apparatus can be movable by hand. An advantage is that the use of motors for the braking and steering device can be omitted and the costs can be kept to a low level.

In a further embodiment, the apparatus can be a C-arm x-ray imaging device.

### BRIEF DESCRIPTION OF THE DRAWINGS

FIG. 1 is a perspective view of a braking device with two arrestable Bowden cable elements.

FIG. 2: is a side view of a braking device with an arrestable Bowden cable element.

FIG. 3 is a perspective view of a braking device with two Bowden cable elements and separate brake handle elements.

FIG. 4 is a side view of a wheel brake in an unbraked state.

FIG. 5 is a side view of a wheel brake in a braked state.

FIG. 6 is a perspective view of a steering device with a Bowden cable element.

FIG. 7 is a side view of a steering device with a Bowden cable element.

FIG. 8 is a perspective view of a combined braking and steering device with a common braking-steering element.

### DESCRIPTION OF THE PREFERRED EMBODIMENTS

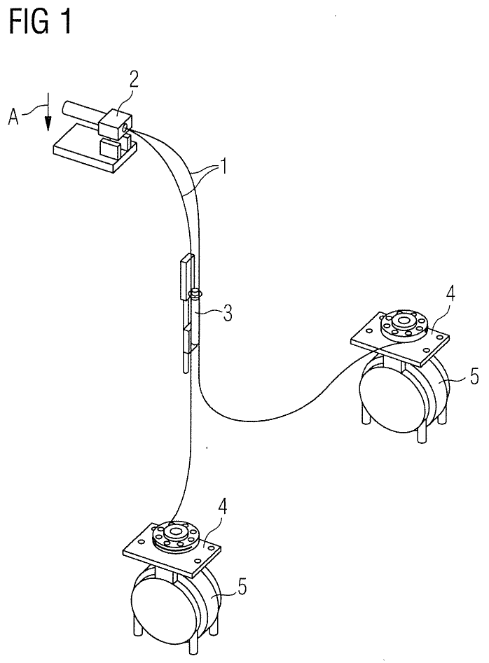

A perspective view of a braking device according to the invention with two arrestable Bowden cable elements 1 is shown in FIG. 1. Two Bowden cable elements 1 that are attached to a common brake handle element 2 are guided through a locking device 3 to a respective wheel brake element 4. The braking of a respective wheel 5 ensues via the wheel brake element 4. Upon actuation of the brake handle element 2 in the arrow direction A, draw forces are transferred via the two Bowden cable elements 1 to a respective wheel brake element 4 and lead to the braking of each wheel 5. The placement of the wheel brake element 4 can be arrested via a locking device 3.

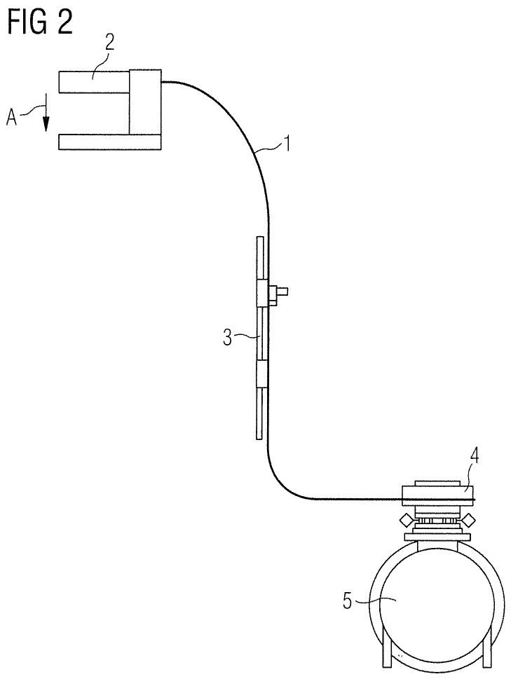

FIG. 2 shows in a side view a braking device to brake a wheel 5, with a Bowden cable element 1 that can be arrested via a locking device 3. The braking function is produced as described in FIG. 1.

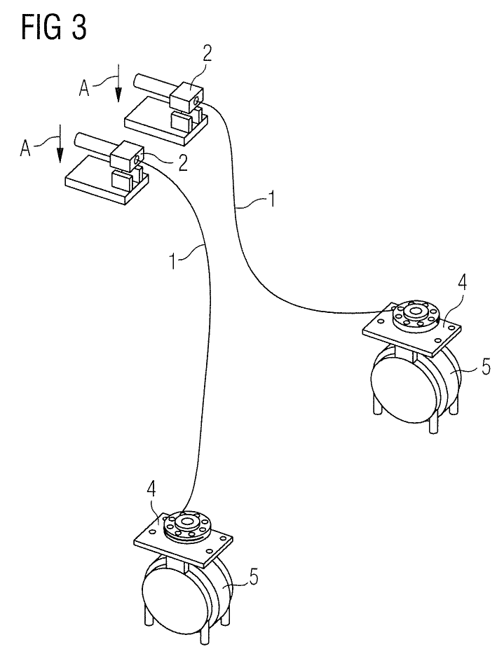

FIG. 3 shows a perspective view of a braking device with two Bowden cable elements 1 and separate brake handle elements 2, without a locking device for the Bowden cable elements 1. The two Bowden cable elements 1 are attached to a respective brake handle element 2 and, upon actuation of the brake handle element 2 in the arrow direction A, lead to the braking of the wheels 5 as shown in FIG. 1.

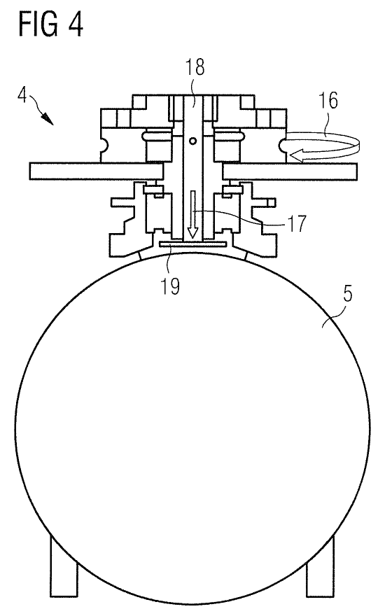

A side view of a wheel brake element 4 in the unbraked state is shown in FIG. 4. A draw force exerted via a Bowden cable element 1 (not shown) leads to the conversion of a rotation motion 16 into a longitudinal motion 17 in the wheel brake element 4, whereby a brake piston 18 at whose end a braking means 19 is arranged is pressed onto a wheel 5, whereby a braking effect is deployed.

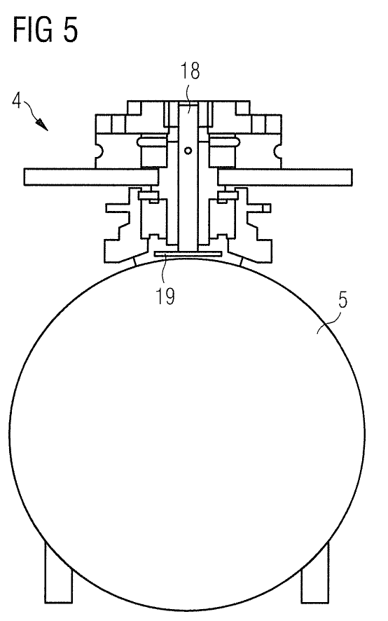

FIG. 5 shows a side view of a wheel brake element 4 in a braked state. The conversion of a rotation motion 16 into a longitudinal motion 17 is produced as described in FIG. 4. A brake piston 18 at whose end a braking means 19 is arranged is pressed onto a wheel 5, whereby a braking effect is deployed.

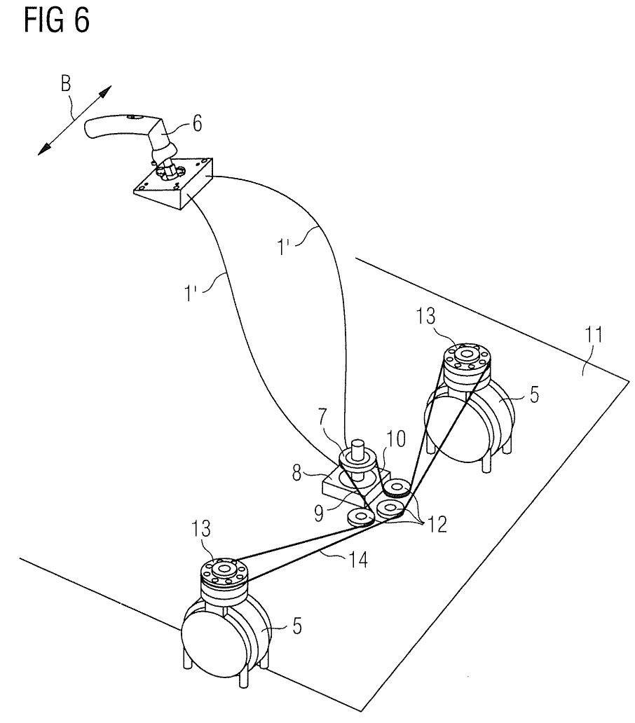

FIG. 6 shows a perspective view of a steering device with a Bowden cable element 1′. The Bowden cable element 1′ that is attached at both ends to a steering handle element 6 is directed around a first gearwheel 7. The steering motion exerted in arrow direction B via the steering handle element 6 is relayed via the Bowden cable element 1′ to the first gearwheel 7 and from there downward via a shaft 8 where it is transferred to a second gearwheel 9. The first gearwheel 7 and the second gearwheel 9 are attached to a gearwheel mounting device 10 such that they can rotate. Three guide gearwheels 12 are attached to the top side of a floor plate 11 of the mobile medical diagnostic or therapy apparatus such that they can rotate. A third gearwheel 13 is rigidly attached to two wheels 5. A chain 14 is directed around the second gearwheel 9, the three guide gearwheels 12 and around the two third gearwheels 13. The steering motion transferred to the second gearwheel 9 is transferred to the chain 14 and leads to the rotation of the two third gearwheels 13. A rotation motion of the wheels 5 ensues due to the rigid attachment of the third gearwheels 13 to the wheels 5.

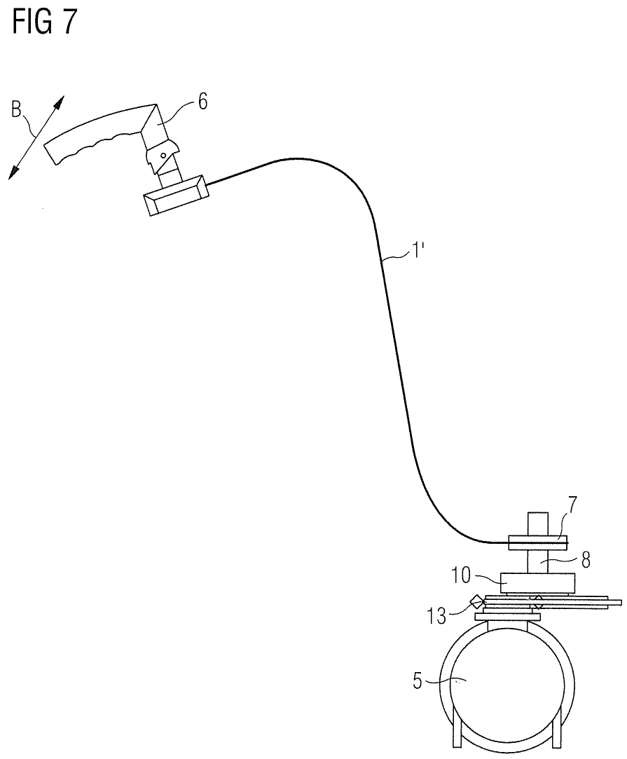

FIG. 7 shows a side view of a steering device to steer a wheel 5 with a Bowden cable element 1′. The steering function is achieved as described in FIG. 6. Due to the side view, a second gearwheel 9, a guide gearwheel 12 and a chain 14 are not shown.

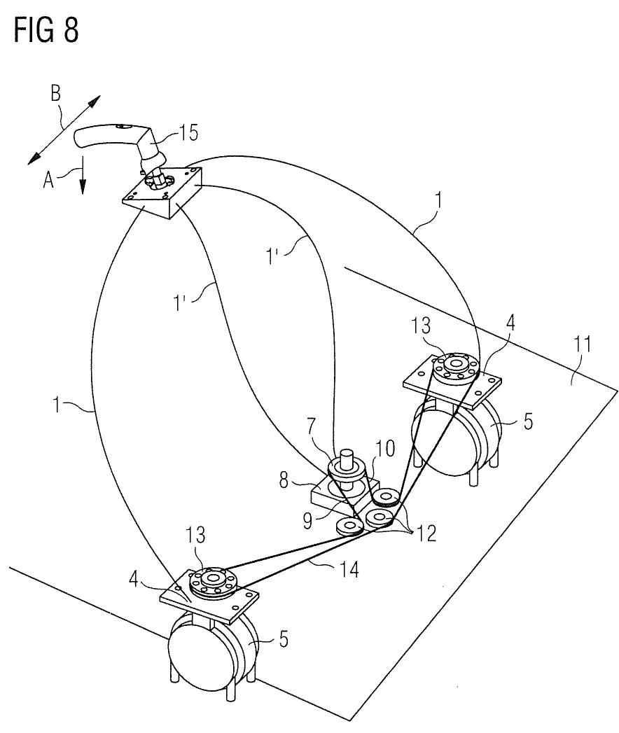

A perspective view of a braking device with two Bowden cable elements 1, a steering device with a Bowden cable element 1′ and a braking-steering handle element 15 is shown in FIG. 8. Two Bowden cable elements 1 are attached to the braking-steering handle element 15 and lead to the raking of the wheels 5 as shown in FIG. 1 upon actuation of the braking-steering handle element 15 in arrow direction A. An additional Bowden cable element 1′ is likewise attached at both ends of the braking-steering handle element 15 and, by means of gearwheels (7, 9, 12, 13) given a steering motion exerted in arrow direction B via the braking-steering element 15, leads to the steering of the wheels 5 as shown in FIG. 6.

Although modifications and changes may be suggested by those skilled in the art, it is the intention of the inventors to embody within the patent warranted hereon all changes and modifications as reasonably and properly come within the scope of their contribution to the art.

We claim as our invention:

1. A mobile medical diagnostic or therapy apparatus, comprising:
a mobile chassis that executes travel movement;
a plurality of components mounted on and carried by said mobile chassis, said components being selected from the group consisting of medical diagnostic components and medical therapy components; and
at least one Bowden cable element that mechanically interacts with said chassis to control said travel movement thereof.

2. An apparatus as claimed in claim 1 comprising a braking device that controls said travel movement.

3. An apparatus as claimed in claim 2 wherein said braking device comprises said at least one Bowden cable element.

4. An apparatus as claimed in claim 3 wherein said at least one Bowden cable element is operable to be arrested to effect braking of said travel movement.

5. An apparatus as claimed in claim 3 wherein said braking device comprises a handle that embodies a portion of said at least one Bowden cable element, said at least Bowden cable element being manually operable via said handle.

6. An apparatus as claimed in claim 1 comprising a steering device that controls said travel movement.

7. An apparatus as claimed in claim 6 wherein said steering device comprises said at least one Bowden cable element.

8. An apparatus as claimed in claim 7 wherein said steering device comprises at least one gear wheel operated by said at least one Bowden cable element.

9. An apparatus as claimed in claim 7 wherein said chassis comprises front wheel and rear wheels, and wherein said steering device, by operation of said at least one Bowden cable element, steers at least one wheel along said front wheels and rear wheels.

10. An apparatus as claimed in claim 7 wherein said steering device comprises a handle embodying a portion of said at least one Bowden cable element, said at least one Bowden cable element being manually operable via said handle.

11. An apparatus as claimed in claim 1 wherein said chassis is manually movable to execute said travel movement.

12. An apparatus as claimed in claim 1 wherein said chassis and said components carried thereby form a C-arm x-ray imaging device.
